(19) United States
(12) Patent Application Publication
(10) Pub. No.: US 2008/0275587 A1
(43) Pub. Date: Nov. 6, 2008

(54) FAULT DETECTION ON A MULTIVARIATE SUB-MODEL

(75) Inventor: Ernest D. Adams, Austin, TX (US)

Correspondence Address: WILLIAMS, MORGAN & AMERSON, 10333 RICHMOND, SUITE 1100, HOUSTON, TX, 77042, US

(73) Assignee: Advanced Micro Devices, Inc.

(21) Appl. No.: 12/127,644

(22) Filed: May 27, 2008

Related U.S. Application Data
(63) Continuation of application No. 10/254,210, filed on Sep. 25, 2002, now abandoned.

(51) Int. Cl. G06F 19/00

(52) U.S. Cl. 700/110

(57) ABSTRACT

A method and an apparatus are provided for fault detection based on a multivariate sub-model. A method and apparatus is provided for fault detection on a multivariate sub-model. The method comprises defining a first model associated with a first sub-system of a processing tool, defining a second model associated with a second sub-system of the processing tool and detecting a fault associated with at least one of the first sub-system based on the first model and the second sub-system based on the second model.

### BACKGROUND OF THE INVENTION

1. Field of the Invention

This invention relates generally to an industrial process, and, more particularly, to detecting faults based on a multivariate sub-model in a semiconductor fabrication process.

2. Description of the Related Art

There is a constant drive within the semiconductor industry to increase the quality, reliability and throughput of integrated circuit devices, e.g., microprocessors, memory devices, and the like. This drive is fueled by consumer demands for higher quality computers and electronic devices that operate more reliably. These demands have resulted in a continual improvement in the manufacture of semiconductor devices, e.g., transistors, as well as in the manufacture of integrated circuit devices incorporating such transistors. Additionally, reducing the defects in the manufacture of the components of a typical transistor also lowers the overall cost per transistor as well as the cost of integrated circuit devices incorporating such transistors.

Generally, a set of processing steps is performed on a group of wafers, sometimes referred to as a “lot,” using a variety of processing tools, including photolithography steppers, etch tools, deposition tools, polishing tools, rapid thermal processing tools, implantation tools, etc. The technologies underlying semiconductor processing tools have attracted increased attention over the last several years, resulting in substantial improvements.

One technique for improving the operation of a semiconductor processing line includes using a factory wide control system to automatically control the operation of the various processing tools. The manufacturing tools communicate with a manufacturing framework or a network of processing modules. Each manufacturing tool is generally connected to an equipment interface. The equipment interface is connected to a machine interface, which facilitates communications between the manufacturing tool and the manufacturing framework. The machine interface can generally be part of an Advanced Process Control (APC) system. The APC system initiates a control script based upon a manufacturing model, which can be a software program that automatically retrieves the data needed to execute a manufacturing process. Often, semiconductor devices are staged through multiple manufacturing tools for multiple processes, generating data relating to the quality of the processed semiconductor devices.

During the fabrication process, various events may take place that affect the performance of the devices being fabricated. That is, variations in the fabrication process steps result in device performance variations. Factors, such as feature critical dimensions, doping levels, particle contamination, film optical properties, film thickness, film uniformity, etc., all may potentially affect the end performance of the device. Various tools in the processing line are controlled in accordance with performance models to reduce processing variation. Commonly controlled tools include photolithography steppers, polishing tools, etching tools, and deposition tools. Pre-processing and/or post-processing metrology data is supplied to process controllers for the tools. Operating recipe parameters, such as processing time, are calculated by the process controllers based on the performance model and the metrology data to attempt to achieve post-processing results as close to a target value as possible. Reducing variation in this manner leads to increased throughput, reduced cost, higher device performance, etc., all of which equate to increased profitability.

Semiconductor manufacturing systems have become more reliable and robust over the past few years. However, as these semiconductor manufacturing systems become more sophisticated, the task of monitoring the semiconductor processes in these systems for the purposes of detecting and classifying faults becomes increasingly difficult. This is because such systems may involve tracking numerous variables, each of which, either alone in combination with other variables, may have contributed to the fault. Thus, there is a need to more efficiently perform fault detection in a manufacturing process where a large number of variables may be monitored and subsequently processed.

The present invention is directed to overcoming, or at least reducing the effects of, one or more of the problems set forth above.

### SUMMARY OF THE INVENTION

In one embodiment of the present invention, a method is provided for fault detection on a multivariate sub-model. The method comprises defining a first model associated with a first sub-system of a processing tool, defining a second model associated with a second sub-system of the processing tool and detecting a fault associated with at least one of the first sub-system based on the first model and the second sub-system based on the second model.

In another embodiment of the present invention, an apparatus is provided for fault detection based on a multivariate sub-model. The apparatus comprises an interface and a controller. The interface is communicatively coupled to a first sub-system and a second sub-system of a processing tool. The controller is communicatively coupled to the interface. The controller is adapted to detect a fault associated with at least one of the first sub-system based on a first model and the second sub-system based on a second model. The first model is representative of the first sub-system and the second model is representative of the second sub-system.

In a further embodiment of the present invention, an article comprising one or more machine-readable storage media containing instructions is provided for fault detection based on a multivariate sub-model. The one or more instructions, when executed, enable the processor to receive trace data from a processing tool and compare the trace data with at least a first process model and a second process model to detect a fault associated with the processing tool. The first process model is representative of a process performed by a first portion of the processing tool and the second process model is representative of a process performed by a second portion of the processing tool.

In another embodiment of the present invention, an apparatus is provided for fault detection based on a multivariate sub-model. The apparatus comprises an interface communicative coupled to a controller. The interface is adapted to receive data from at least one of a first portion and a second portion of a processing tool. The controller is adapted to detect a fault by comparing the trace data with at least one of the first process model and second process model. The first process model and the second process model are representative of the respective first portion and the second portion of the processing tool.

In a further embodiment of the present invention, a system is provided for fault detection based on a multivariate sub-model. The system comprises a processing tool and a fault detection unit. The system has at least a first sub-system and a second sub-system. The fault detection unit is adapted to detect a fault associated with the first sub-system using a first process model and a fault associated with the second sub-system using a second process model. The first process model and the second process model are representative of a process performed by the first sub-system and second sub-system, respectively.

### BRIEF DESCRIPTION OF THE DRAWINGS

The invention may be understood by reference to the following description taken in conjunction with the accompanying drawings, in which like reference numerals identify like elements, and in which:

FIG. 1 illustrates a block diagram of system for implementing an industrial process, in accordance with one embodiment of the present invention;

FIG. 2 depicts a flow diagram of a method that may be implemented in the system of FIG. 1, in accordance with one embodiment of the present invention; and

FIG. 3 illustrates a flow diagram of a method that may be implemented in the manufacturing system of FIG. 1, in accordance with one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

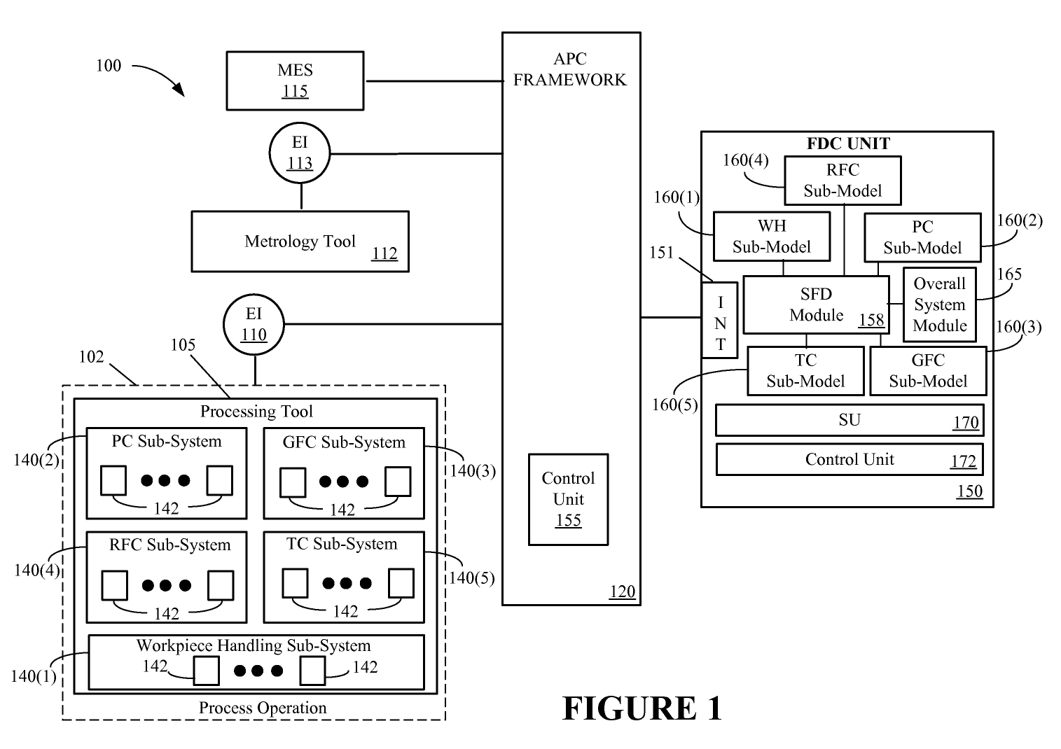

Turning now to the drawings, and specifically referring to FIG. 1, a block diagram of a system 100 is illustrated, in accordance with one embodiment of the present invention. The system 100, in the illustrated embodiment, performs at least one process operation 102 for implementing an industrial process, such as a semiconductor fabrication process, a photographic process, a chemical process, or any other process in which a plurality of variables, such as temperature, tool parameters, pressure level and chemical compositions, and the like may be monitored and analyzed. The variables may be monitored and analyzed, for example, to detect faults and/or classify the detected faults.

In the system 100, the process operation 102 may be performed using a processing tool 105. Generally, the particular type of process operation 102 that is performed, and the type of processing tool 105 employed in that process operation 102, depends on the particular implementation. For example, in the context of a chemical industrial process, the process operation 102 may include processing a polymer. In the context of a photographic process, the process operation 102 may, for example, include processing a film.

For illustrative purposes, the process operation 102 depicted in FIG. 1 is at least a portion of a semiconductor fabrication process, which, for example, may be part of an overall semiconductor process flow. The processing tool 105, in the illustrated embodiment, may take the form of any semiconductor fabrication equipment used to produce a processed workpiece, such as a silicon wafer. The semiconductor process may be utilized to produce a variety of integrated circuit products including, but not limited to, microprocessors, memory devices, digital signal processors, application specific integrated circuits (ASICs), or other similar devices. An exemplary processing tool 105 may include an exposure tool, an etch tool, a deposition tool, a polishing tool, a rapid thermal anneal processing tool, a test-equipment tool, an ion implant tool, a packaging tool and the like. It should be appreciated that the processing tool 105 need not necessarily be limited to processing silicon wafers, but may produce a variety of different types of commercial products without departing from the spirit and scope of the present invention.

As described in more detail below, in accordance with one or more embodiments of the present invention, an efficient fault detection system is disclosed. Fault detection, for example, is performed at a sub-system level of the processing tool 105, which allows a fab engineer to tighten control/fault detection limits for that sub-system, thereby resulting in greater sensitivity to problems. In one embodiment, and as described below, the data from the various sub-systems of the processing tool 105 may be utilized to gauge the overall performance level of the processing tool 105.

In the system 100 of FIG. 1, the processing tool 105 has an associated equipment interface 110, and a metrology tool 112 has an associated equipment interface 113, for interfacing with an Advanced Process Control (APC) framework 120. In the illustrated embodiment, the metrology tool 112 measures aspects of the workpieces that are processed in the process operation 102.

The manufacturing system 100 may include a manufacturing execution system (MES) 115 that is coupled to the APC frame work 120. The manufacturing execution system 115 may, for example, determine the processes that are to be performed by the processing tool 105, when these processes are to be performed, how these processes are to be performed, etc. In the illustrated embodiment, the manufacturing execution system 115 manages and controls the overall system through the APC framework 120. The APC framework 120 includes a process control unit 155 that, through a feedback process, aids the processing tool 105 towards performing a desired process to thereby achieve a desired result.

An exemplary APC framework 120 that may be suitable for use in the manufacturing system 100 may be implemented using the Catalyst system offered by KLA-Tencor, Inc. The Catalyst system uses Semiconductor Equipment and Materials International (SEMI) Computer Integrated Manufacturing (CIM) Framework compliant system technologies and is based on the Advanced Process Control (APC) Framework. CIM (SEMI E81-0699-Provisional Specification for CIM Framework Domain Architecture) and APC (SEMI E93-0999-Provisional Specification for CIM Framework Advanced Process Control Component) specifications are publicly available from SEMI, which is headquartered in Mountain View, Calif.

For illustrative purposes, the depicted processing tool 105 is an etch tool. The processing tool 105, in the illustrated embodiment, is represented by a plurality of sub-systems 140(1-5), where each sub-system 140 may generally perform one or more functions for the processing tool 105. For example, the first sub-system 140(1) is a workpiece handling sub-system that moves workpieces (e.g., wafers) in and out of the processing tool 105. The workpiece handling sub-system, in one embodiment, may also be responsible for transporting the workpieces within the processing tool 105, such as from one chamber to another. Generally, a group of selected components within the processing tool 105 may be designated as a “sub-system” based on the function performed by those components. In alternative embodiments, any other suitable criteria may be utilized to designate “sub-systems” in a processing tool 105. In one embodiment, each chamber of a processing tool 105 may be a “sub-system.”

In the illustrated embodiment, the second sub-system 140(2) of the processing tool 105 includes a pressure control (PC) sub-system for controlling the temperature within the chamber(s) (not shown) of the processing tool 105. The third sub-system 140(3) includes a gas flow control (GFC) sub-system to govern the mass flow rate of the gas into the chamber(s) of the processing tool 105. The fourth sub-system 140(4) is a radio frequency control (RFC) sub-system for converting the gas into plasma or other desirable material. The fifth sub-system 140(5) is a temperature control (TC) sub-system for regulating the temperature level(s) within the chamber(s) of the processing tool 105.

Each of the sub-systems 140(1-5) of the processing tool 105 may include one or more sensors 142 for measuring a variety of variables in that respective sub-system 140(1-5). Examples of various types of variables that may be measured include temperature, pressure, and concentrations of gas mixtures or chemical agents employed by the processing tool 105 (or in the process operation 102), and the like. The measurements taken by the sensors 142 may then be used to detect faults associated with the sub-systems 140(1-5), as described in greater detail below.

The manufacturing system 100, in the illustrated embodiment, also includes a fault detection and classification (FDC) unit 150 that is coupled to the APC framework 120 via an interface 151. The interface 151 may be any acceptable structure(s) that allow(s) the FDC unit 150 to communicate with other devices. In one embodiment, the interface 151 may support a network connection with the processing tool 105.

The FDC unit 150 includes a sub-system fault detection (SFD) module 158, which receives the trace data from the various sub-systems 140(1-5) of the processing tool 105 and determines if a fault associated with any of the sub-systems 140(1-5) has occurred. The trace data may include data related to the processing of workpieces by the sub-systems 140(1-5), data associated with the operating condition of the hardware/software components within the sub-systems 140(1-5), and the like.

In accordance with one embodiment of the present invention, the SFD module 158 detects faults using a variety of process sub-models 160(1-5) stored in the FDC unit 150. The term “sub-model” is utilized herein to denote that a subset portion of the processing tool 105 (as opposed to the entire processing tool 105) is modeled by the corresponding sub-model. Faults may occur in the sub-systems 140(1-5) for various reasons, including occurrence of an unknown disturbance, hardware failure, depletion of resources (e.g., gases, liquids, chemicals), and the like. The faults may be detected in several ways. One way is to compare processing data that is associated with the sub-systems 140(1-5) to a process model (or a sub-model), where the process model may be generated based on history data that was previously collected from the same or other similar-type tools. The data provided by the sub-systems 140(1-5) may include substantially real-time data (sometimes referred to as “trace data”) or (in-line/off-line) metrology data, or both trace and metrology data.

In the illustrated embodiment, the process sub-models 160(1-5) are representative of the process performed by the respective sub-systems 140(1-5) of the processing tool 105. Specifically, the workpiece handling (WH) sub-model 160(1), pressure control (PC) sub-model 160(2), gas flow control (GFC) sub-model 160(3), radio frequency control (RFC) sub-model 160(4), and temperature control (TC) sub-model 160(5) are representative of the process performed by the workpiece handling, pressure control, gas flow, radio frequency, and temperature control sub-systems 140(1-5), respectively.

The FDC unit 150 of FIG. 1 includes an overall system module 165, which may include an overall process model for the processing tool 105. In the illustrated embodiment, the sub-system fault detection module 158 provides performance-related data associated with the sub-systems 140(1-5) of the processing tool 105 to the overall system module 165, which then, based on the performance-related data, determines the overall performance of the processing tool 105 (or process operation 102).

The modules 158, 165 may be implemented in hardware, software, or a combination thereof, although, in the illustrated embodiment, these modules 158, 165 are implemented in software, and may be stored in a storage unit (SU) 170. The FDC unit 150 includes a control unit 172 for managing the overall operations and executing one or more software applications resident in the storage unit 170.

It should be understood that the illustrated components shown in the block diagram of the system 100 in FIG. 1 are illustrative only, and that, in alternative embodiments, additional or fewer components may be utilized without deviating from the spirit or scope of the invention. For example, the processing tool 105 may have fewer or additional sub-systems 140(1-5). Additionally, it should be noted that although various components, such as the equipment interface 110 of the system 100 of FIG. 1 are shown as stand-alone components, in alternative embodiments, such components may be integrated into the processing tool 105. Similarly, the FDC unit 150 may be integrated into the APC framework 120. Additionally, the storage unit 170 of the FDC unit 150 may be located at any suitable location in the manufacturing system 100 such that various components of the manufacturing system 100 can access the contents stored therein.

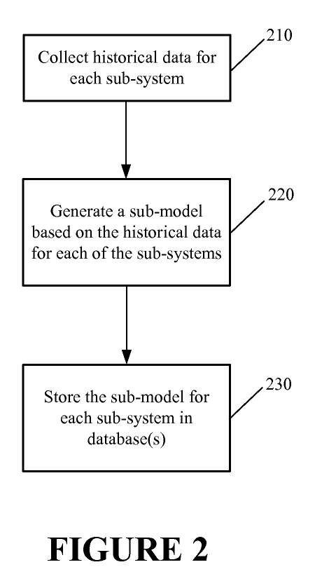

Referring now to FIG. 2, a flow diagram of a method that may be implemented in the system 100 is illustrated, in accordance with one embodiment of the present invention. FIG. 2 illustrates a method of creating process sub-models 160 representative of each of the sub-systems 140(1-5) of the processing tool 105 that can later be used by the FDC unit 150 to detect one or more faults associated with the sub-systems 140(1-5) of the processing tool 105. As an initial process, history data is collected (at 210) for each of the sub-systems 140. The history data can be a collection of numerous data points, where each data point may be representative of one or more variables that are measured or monitored in the sub-systems 140 during a process operation. For example, if 10 variables are monitored in a given process operation of the sub-systems 140, then each data point, which is said to have 10 dimensions, represents a measurement of the 10 different variables. Generally, the number of samples collected for the history data should be at least 5 times the number of variables measured or monitored, although the ratio between the number of samples and the number of variables can vary from implementation to implementation.

Based on the data collected (at 210), the sub-models 160(1-5) are generated (at 220). In one embodiment, the process sub-models 160(1-5) may be generated using principal component analysis (PCA). Principal component analysis, which is a well known technique to those skilled in the art, involves a mathematical procedure that transforms a number of (possibly) correlated variables into a (smaller) number of uncorrelated variables called principal components. The first principal component accounts for as much of the variability in the data as possible, and each succeeding component accounts for as much of the remaining variability as possible. It should be understood that, in other embodiments, the process sub-models 160(1-5) may be generated using any other suitable mathematical procedure aside from PCA.

The process sub-models 160(1-5), once generated (at 220), can be stored (at 230) in database(s). The database(s), for example, may reside in the storage unit 170 of the FDC unit 150. The term “database,” as utilized herein, may be a text file, a repository under the control of a database program, or any other desirable storage format.

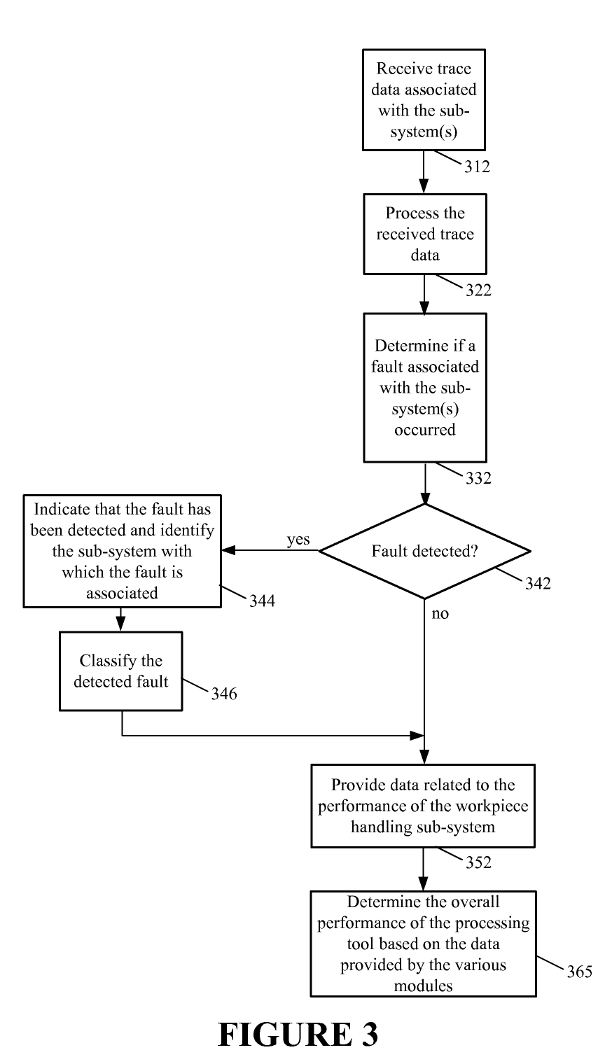

Referring now to FIG. 3, a flow diagram of a method that may be implemented in the system 100 is illustrated, in accordance with one embodiment of the present invention. The method of FIG. 3 is described in the context of processing one or more wafers using the processing tool 105. The sensors 142 of the sub-systems 140(1-5) of the processing tool 105 measure pre-selected variables as the wafer(s) is/are processed by the sub-systems 140(1-5). The trace data, which is representative of the measurements, is provided to the sub-system fault detection (SFD) module 158 of the FDC unit 150. In one embodiment, the trace data is provided to the SFD module 158 in substantially real time.

The SFD module 158 may receive (at 312) the trace data from one or more of the sub-systems 140(1-5) of the processing tool 105 as those sub-systems 140(1-5) process the wafer(s). Thus, in the illustrated embodiment, the workpiece handling sub-system 140(1), pressure control sub-system 140(2), gas flow control sub-system 140(3), radio frequency sub-system 140(4), and temperature control sub-system 140(5) provide the trace data to the SFD module 158.

In one embodiment, the trace data that is received (at 312) may include data sample(s) that are representative of one or more measurements associated with the processing of the wafer(s). Each new data sample may be an n-dimensional vector, where “n” represents the number of different variable(s) that is/are measured in association with the processing of the wafer.

The SFD module 158 processes (at 322) the received trace data (at 312). Processing the received trace data (at 322), in one embodiment, may include calculating a performance statistic for the sub-system 140 from which the trace data is received. The performance statistic may be used to determine if a fault associated with a sub-system 140 has occurred. In one embodiment, the act of processing the received trace data (at 322) may include scaling the data sample(s) of the trace data by a preselected value and then projecting the data sample(s) into the principal component subspace. Scaling and projecting the data sample(s) may be desired, for example, if the process sub-models 160(1-5) themselves have been mapped to a principal component subspace.

The SFD module 158 determines (at 332) if a fault associated with the sub-systems 140(1-5) has occurred. In accordance with one embodiment of the present invention, to determine faults (at 332) with a particular sub-system 140, the SFD module 158 uses the appropriate process sub-model 160 stored in the FDC unit 150. That is, to detect faults associated with the workpiece handling sub-system 140(1), the trace data received from the workpiece handling sub-system 140(1) is compared or applied to the workpiece handling sub-model 160(1). Similarly, the fault detection for the other sub-systems 140(2-5) is based on comparing or applying the received trace data with the respective sub-models 160(2-5).

In one embodiment, as noted above, the performance statistic that is calculated for a sub-system 140 may be used to determine (at 332) if a fault associated with at least one of the sub-systems 140(1-5) has occurred. A fault, for example, may be determined if the performance statistic is greater than a preselected threshold value. Conversely, a performance statistic that is less than or equal to the preselected value may indicate that the sub-system 140 is performing within an acceptable range or as desired. In one embodiment, if employing principal component analysis is performed on the trace data, the performance statistic may be calculated based on the squared prediction error (SPE) or Hotelling's T², or a combination thereof. As understood by those skilled in the art, in the context of principal component analysis, SPE is a measure of variations in a residual subspace, and T² is a measure of variations in a principal component subspace.

If a fault associated with at least one of the sub-systems 140(1-5) is detected (at 342), then the SFD module 158 indicates (at 344) that a fault was detected and identifies the sub-system 140 with which that fault is associated. If a fault is detected in more than one sub-system 140, then the SFD module 158 identifies each sub-system 140 in which the faults occur. In one embodiment, the SFD module 158 may classify (at 346) the detected fault. Classifying the fault (at 346) may entail identifying the source or cause of the fault.

The SFD module 158 provides (at 352) data related to the performance of each sub-system 140 to the overall system module 165 of the FDC unit 150. In one embodiment, the SFD module 158 may provide the performance statistics calculated for the sub-systems 140(1-5) to the overall system module 165. The overall system module 165 determines (at 365) the overall performance of the processing tool 105 based at least on the performance-related data provided (at 352) by the SFD module 158. In one embodiment, the overall system module 365 may use a process model representative of the entire processing tool 105 to assess the overall performance of the processing tool 105.

One advantage of performing fault detection at a sub-system level is that it can reduce the amount of data that needs to be processed to detect faults because a sub-system 140 is likely to have a smaller number of sensors 142 associated therewith as compared to an entire processing tool 105. Furthermore, when sensors 142 associated with each sub-system 140 are grouped into their own process sub-model 160, it is possible to reduce the number of inputs to that process sub-model 160 to a small set of related sensors 142. This allows a fab engineer to tighten control/fault detection limits for that sub-system 140, thereby resulting in greater sensitivity to problems/issues.

Performing fault detection at a sub-system 140 level, in accordance with one or more embodiments of the present invention, can have an additional advantage, as illustrated by an example below. In an etch tool, the tool etch rate is typically affected by the amount of ‘active’ plasma available, temperature of the wafer, chamber conditions, and the like. If the gas flow gradually decreases, the etch tool may, for example, increase the wafer temperature to maintain the etch rate. If a process sub-model 160 is applied at a sub-system 140 level, such as to the gas flow sub-system 140(3) and the temperature control sub-system 140(5), the problem can readily be identified and properly addressed before any future complications arise. If, however, a process sub-model 160 were to be applied to the etch tool as a whole, the drift in the modeled output could be attributed to a false fault because the output of the etch tool (material removed) did not change. However, down the line, when the etch tool may not be able to account for the drift anymore, a batch of wafers could be lost due to a fault that should have been caught and repaired earlier.

The various system layers, routines, or modules may be executable by the control unit 155, 172 (see FIG. 1). As utilized herein, the term “control unit” may include a microprocessor, a microcontroller, a digital signal processor, a processor card (including one or more microprocessors or controllers), or other control or computing devices. The storage unit 170 (see FIG. 1) referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A method, comprising:
defining a first model associated with a first sub-system of a processing tool;
defining a second model associated with a second sub-system of the processing tool, the second model being a different mathematical procedure from the first model; and
detecting a fault associated with at least one of the first sub-system based on the first model and the second sub-system based on the second model.

2. The method of claim 1, wherein detecting the fault comprises receiving trace data associated with processing of a workpiece from at least one of the first sub-system and the second sub-system.

3. The method of claim 1, wherein the processing tool is a semiconductor processing tool, further comprising indicating that the fault was detected and identifying at least one of the first sub-system and second sub-system with which the detected fault is associated.

4. The method of claim 1, wherein defining the first model comprises:
collecting history data representative of a process performed by the first sub-system, wherein the number of samples collected for the history data is at least five times greater than the number of variables measured or monitored in the first sub-system; and
performing a principal component analysis on the history data.

5. The method of claim 1, further comprising determining an overall performance statistic of the processing tool based on performance data associated with the first sub-system and the second sub-system.

6. The method of claim 1, further comprising:
defining a third model associated with a third subsystem of the of the processing tool, the third model being substantially similar to the first model;
detecting the fault by receiving trace data associated with a workpiece from at least one of the first, second and third sub-systems, calculating at least one of a squared prediction error and Hotelling's T² based on at least a portion the trace data, and scaling the data samples of the trace data by a preselected value and then projecting the data samples into the principal component subspace; and
classifying a fault associated with at least one of the first, second and third sub-systems wherein the first, second and third sub-systems are at least one of a workpiece handling sub-system, a pressure control sub-system, a gas flow control sub-system, a radio frequency control subsystem and, a temperature control sub-system.

7. The method of claim 1, wherein detecting the fault comprises:
receiving trace data associated with a workpiece from at least one of the first sub-system and the second sub-system;
calculating at least one of a squared prediction error and Hotelling's T² based on at least a portion of the trace data, and
scaling the data samples of the trace data by a preselected value and then projecting the data samples into the principal component subspace.

8. An apparatus, comprising:
an interface communicatively coupled to a first sub-system and a second sub-system of a processing tool; and
a controller communicatively coupled to the interface, the controller adapted to detect a fault associated with at least one of the first sub-system based on a first model and the second sub-system based on a second model, wherein the first model is representative of the first sub-system and the second model is representative of the second sub-system, the second model being a different mathematical procedure from the first model.

9. The apparatus of claim 8, wherein the interface is adapted to receive trace data from at least one of the first sub-system and the second sub-system, and wherein the controller is adapted to detect the fault based on comparing the trace data with at least one of the first model and the second model.

10. The apparatus of claim 8, wherein the controller is further adapted to classify the detected fault.

11. The apparatus of claim 8, wherein the controller is adapted to determine an overall performance statistic of the processing tool based on performance data associated with the first sub-system and the second sub-system.

12. The apparatus of claim 8, wherein the controller is adapted to detect the fault based on a combination of Hotelling's T² and squared prediction error and scale the data samples of the trace data by a preselected value and then projecting the data samples into the principal component subspace.

13. The apparatus of claim 8, wherein the interface is communicatively coupled to a third sub-system of the processing tool, and wherein the controller is further adapted to detect a fault associated with the third sub-system based on a third model that is representative of the third sub-system.

14. The apparatus of claim 8, wherein the first model is representative of a semiconductor process performed by the first sub-system and the second model is representative of a semiconductor process performed by the second sub-system.

15. An apparatus, comprising:
means for defining a first model associated with a first sub-system of a processing tool;
means for defining a second model associated with a second sub-system of the processing tool, the second model being a different mathematical procedure from the first model; and
means for detecting a fault associated with at least one of the first sub-system based on the first model and the second sub-system based on the second model.

16. An article comprising one or more machine-readable storage media containing instructions that when executed enable a processor to:
receive trace data from a processing tool; and
compare the trace data with at least a first process model and a second process model the second process model being a different mathematical procedure from the first process model to detect a fault associated with the processing tool, wherein the first process model is representative of a process performed by a first portion of the processing tool and the second process model is representative of a process performed by a second portion of the processing tool.

17. The article of claim 16, wherein the instructions when executed enable the processor to determine an overall performance statistic for the processing tool based on the first process model and the second process model.

18. The article of claim 16, wherein the instructions when executed enable the processor to perform principal component analysis on the trace data.

19. The article of claim 16, wherein the instructions when executed enable the processor to receive the trace data from the processing tool of a semiconductor manufacturing system.

20. The article of claim 19, wherein the instructions when executed enable the processor to scale data samples of the trace data by a preselected value then project the data samples into the principal component subspace, and classify the detected fault.

21. An apparatus, comprising:
an interface adapted to receive data from at least one of a first portion and a second portion of a processing tool; and
a controller communicatively coupled to the interface, the controller adapted to detect a fault by comparing the trace data with at least one of the first process model and second process model, the second process model being a different mathematical procedure from the first process model, wherein the first process model and the second process model are representative of the respective first portion and the second portion of the processing tool.

22. The apparatus of claim 21, wherein the first process model is representative of a semiconductor process performed by the first portion and the second process model is representative of a semiconductor process performed by the second portion of the processing tool.

23. The apparatus of claim 21, wherein the controller is further adapted to determine an overall performance statistic of the processing tool based on at least the first and second process models.

24. A system, comprising:
a processing tool having at least a first sub-system and a second sub-system; and
a fault detection unit adapted to detect a fault associated with the first sub-system using a first process model and a fault associated with the second sub-system using a second process model, the second process model being a different mathematical procedure from the first process model, wherein the first process model and the second process model are representative of a process performed by the first sub-system and second sub-system, respectively.

25. The system of claim 24, wherein an advanced process control is coupled between the processing tool and the fault detection unit.
